(19) United States
(12) Patent Application Publication
(10) Pub. No.: US 2016/0362144 A1
(43) Pub. Date: Dec. 15, 2016

(54) HYBRID COMPONENT AND METHOD FOR PRODUCING THE HYBRID COMPONENT

(71) Applicant: BENTELER Automobiltechnik GmbH, Paderborn (DE)

(72) Inventor: Simon POTTHAST, Paderborn (DE)

(73) Assignee: BENTELER Automobiltechnik GmbH, Paderborn (DE)

(21) Appl. No.: 15/181,951

(22) Filed: Jun. 14, 2016

(30) Foreign Application Priority Data
Jun. 15, 2015 (DE) 102015109471.1

(51) Int. Cl. B62D 27/02; B23K 31/02; B62D 29/00

(52) U.S. Cl. CPC B62D 27/023; B62D 29/007; B62D 29/008; B23K 31/02; B23K 2203/18

(57) ABSTRACT

The present invention relates to a hybrid component and a method for producing the hybrid component. The hybrid component comprises a steel component 1 and a light metal component 2, wherein the steel component 1 has a recess 3, which extends through the steel component and tapers towards the light metal component 2, the recess being filled with a weld filler material 6, such that owing to the weld filler material 6, the steel component 1 is bonded in a positive locking manner so as to be positionally stabilized.

### BACKGROUND OF THE INVENTION

The present invention relates to a hybrid component, according to the features disclosed in the preamble of patent claims 1 and 2.

The present invention relates to a method for producing a hybrid component, according to the features disclosed in patent claim 12.

### DESCRIPTION OF RELATED ART

It is known from the prior art to produce hybrid components, in particular, for motor vehicles. The term “hybrid component” is defined as a component that is composed of two individual components; and the two individual components are made of materials that are different from each other.

For example, it is known to couple metallic components with plastic components, in particular, components made of fiber reinforced composite material.

However, even metallic components consisting of multiple parts are often produced together. In this case, two different metallic materials are used that cannot in essence be thermally joined to each other or can be thermally joined to each other only under special conditions. This includes, in particular, the coupling of a steel material with a material made of a light metal alloy.

In addition, it has been demonstrated by the prior art that the punch riveting process by means of thermal joining or joining by means of hole-forming screws is useful precisely for mass production. However, the drawback is that it is necessary to use additional auxiliary means, for example, in the case of punch riveting, that, on the one hand, have to be kept in stock and, on the other hand, are associated with higher production costs.

Furthermore, the prior art discloses a weld stud process, in which first a rivet is riveted into a component to be joined; and then the rivet is welded together with the second component to be joined. In this case, too, a riveting process has to be carried out first; and for this purpose, the rivet has to be kept once again in stock and incurs, as an external component, additional costs.

The German patent DE 10 2009 017 376 A1 discloses a method for producing a support structure. This method provides a hole for a first component, which is brought into contact with a second component in a positive locking manner and then in the following step is heated over the length of the entire hole so that a liquefied material is created in the hole, in order to form a rivet-like joint after the material has cooled down. However, all joints that are produced with rivets or joints with rivet shapes have a distinct projecting length. Furthermore, the German patent DE3140368A discloses an articulated shaft made of an aluminum tube, onto which a rotor made of steel sheet is welded. For this purpose, a fusion welding process is carried out, such that a weld pin engages over the outside of the rotor in the manner of a rivet head.

### BRIEF SUMMARY OF THE INVENTION

Therefore, the object of the present invention is to provide, starting from the prior art, a hybrid component and a method for producing the hybrid component, which has two mutually different materials and which can be manufactured inexpensively, reliably and safely.

The aforementioned object is achieved with a hybrid component exhibiting the features disclosed in patent claims 1 and 2.

The process engineering part of the invention is achieved with a method for producing a hybrid component, according to the features disclosed in patent claim 12.

Advantageous variants of the embodiment of the present invention are the subject matter of the dependent patent claims.

The hybrid component comprises a steel component and a light metal component. The hybrid component is designed, in particular, as a hybrid component for a motor vehicle. For this purpose, the steel component rests with its surface flush against the light metal component at least in certain regions or, more specifically, in certain sections. A joint connection engages with the steel component from behind in a positive locking manner. The joint connection is designed in such a way that a recess, which extends through the steel component and tapers towards the light metal component, is formed on the steel component; and a weld filler material, which is coupled with the light metal component by material bonding, engages with the recess from behind. The hybrid component is characterized, according to the invention, by the feature that the weld filler material extends from the light metal component in such a way that it only partially extends through the recess, or by the feature that a surface of the welding material is designed to terminate level with the top side of the steel component.

In an alternative variant of the embodiment, the hybrid component is characterized, according to the invention, by the feature that the steel component is coated; and that the weld filler material is connected to the coating by material bonding.

Thus, it is possible within the scope of the invention to produce the joint connection in a very simple and efficient way and, hence, the coupling of the hybrid component. For this purpose, the steel component is provided with a recess. In this case, the recess can be made, in particular, by punching, however, preferably also by cutting out, for example, with a laser or a water jet cutting process. Both components (steel component, light metal component) are then brought into abutting contact and aligned in relation to each other. Then a weld filler material is put into the recess of the steel component; and a material connection to the light metal component is produced by welding the weld filler material with the light metal component. In so doing, the resulting molten weld filler material mechanically engages with the steel component from behind or undercuts the steel component in a positive locking manner owing to the tapering recess. The advantage that is essential for the invention is that this method can be carried out with already existing production systems, for example, in particular, arc-welding units.

Within the context of the invention, the recess, which tapers towards the light metal component, means, as a highly preferred variant of the embodiment of the invention, that the two components may lie one above the other; and then the recess in the steel component tapers from a top side, which faces away from the light metal component, to a bottom side that abuts the light metal component. However, this can also mean, within the context of the invention, that the steel component and the light metal component only overlap at the edge; and the recess is not closed circumferentially, but rather is open towards the edge of the steel component. Then the weld filler material engages laterally in the steel component in the manner of a piece of a jigsaw puzzle. The recess is formed in such a way that it tapers preferably from the top side to the bottom side of the steel component and, furthermore, also tapers towards the open edge region.

The two components, thus, the steel component and the light metal component, may already have their final contour. However, the two components may also exist first in the form of sheet metal blanks and/or profiles. After the blanks and/or profiles are coupled with the joint connection according to the invention, they may then be fed to a forming process or to any other further processing process.

The recess is designed so as to be, in particular, round, star shaped, angular, in particular, polygonal, as a slot and/or in any combination of the aforementioned variants of the embodiment of the invention. This geometric shape relates largely to the plan view. Thus, in the case of a round, in particular, circular recess and a production by punching, a round recess, which tapers from a top side of the steel component to a bottom side, would be punched into the steel component.

In all cases, an inner circumferential surface of the recess is formed in such a way that it has an oblique course. Thus, said inner circumferential surface does not run at a 90 deg. angle towards the surfaces of the steel component that surround the recess, but rather is slightly beveled, such that the recess, extending through the steel component, tapers in the direction of the light metal component. The inner circumferential surface of the recess extends preferably at an angle of more than 60 deg. and less than 90 deg. to the surface of the steel component, in particular, at an angle of less than or equal to 87 deg. greater than 70 deg. and even more preferably at an angle of less than or equal to 85 deg. and greater than or equal to 75 deg. As a result, the recess has a tapering cross section, where in this case the tapering cross section is formed, in particular, in a V shape or a Y shape. The respective converging legs themselves can have a linear course, but also a digressive or progressive course. However, the important aspect in this case is that the legs taper towards the side of the steel component that is oriented relative to the light metal component.

The taper ensures that the steel component is mechanically held by the weld filler material when hardened. It would also be conceivable within the scope of the invention that the cross section is configured in an X shape or, more specifically, in the shape of an hourglass, such that an upper region is designed to taper first towards the light metal component and then to expand again over the rest of the course.

The weld filler material that is used also includes, in particular, a light metal alloy or an alloy based on copper and/or brass. Preferably, a metal inert gas [MIG] metal active gas [MAG] welding process is used. It is especially preferred that the weld filler material may have a shrinking property on cooling or, more specifically, on solidifying, such that the light metal component is also pressed against the steel component in the coupling region due to the shrinkage of the weld filler material in connection with the taper.

An additional advantage that is essential for the invention consists of the feature that a coated steel component and/or a steel component having high strength or ultra high strength properties is and/or are used. The coating may be, in particular, an anti-corrosion coating, which is even more preferably bonded with the steel component by means of an intermetallic phase. Neither the coating nor the high strength or ultra high strength joining properties of the steel component are appreciably or significantly affected by the coupling process of the invention. For this purpose, a weld filler material is selected; in particular, a weld filler material that has a melting temperature that is less than that of the steel component and, in particular, less than that of the coating, but is at least equal to or higher than the melting point of the light metal component. As a result, the thermal metallurgical process of the weld filler material and the light metal component has a negligible effect or does not have any adverse effect at all on the surrounding material joint of the steel component and/or the coating of the steel component.

Preferably, the steel component has a metallic coating, in particular, an anti-corrosion coating. In this case, the anti-corrosion coating is preferably a zinc coating. It is also possible to provide an aluminum based coating, for example, an aluminum silicon [AlSi] coating. Then the weld filler material preferably also has constituents of zinc and/or aluminum. As a result, there is a good possibility that the weld filler material will couple with the coating by metallurgical bonding.

When the recess is formed, the coating of the steel component is displaced preferably into the circumferential surface of the recess at least to some extent, so that the result is a better metallurgical bonding with the steel component and a geometrically precise, positive locking connection of the parts. Preferably, the weld filler material terminates more or less flush with the top side of the steel sheet component, with the top side being located opposite the light metal component. Within the context of the invention, the term “flush” means that there is a flat surface or an uneven surface, which projects beyond the top side in a humpy manner only due to the process conditions. It is not affected by the weld filler material splattering or flowing on the top side above the inner circumferential surface, a feature that is unavoidable during mass production.

Furthermore, it is particularly preferred that the hybrid component has, in a longitudinal orientation, a plurality of joint connections, in particular, arranged so as to be oriented in a row, where in this case the individual joint connections are spaced apart from each other. This arrangement makes it possible to produce, in particular, a sill or also a pillar of a motor vehicle or, more specifically, a roof pillar as a hybrid component.

Furthermore, it is particularly preferred that a sealing system be arranged over the joint connection on the side opposite the light metal component. This sealing system may be made, for example, of a metallic material. However, it is made preferably of a flexible material, in particular, a plastic and/or rubber material. In particular, the sealing system is glued on and/or vulcanized on. Then, the hybrid component can be used, in particular, in the area of doors and hinged hoods, the A pillar, the C pillar or the D pillar of the vehicle.

In the case of a joint connection, it is possible within the scope of the invention that the joint connection extends from the light metal in such a way that it projects only into the recess or that it penetrates this recess only partially. This arrangement makes it possible to avoid a rivet head that projects beyond the steel component, at or on the joint connection. A sealing system can rest flat without an air gap or can rest with its surface flush against the surface of the steel component, such that the inventive joint connection does not cause any damage to or deformation of the sealing system.

Furthermore, the present invention relates to a method for producing a hybrid component with at least some of the aforementioned properties, the method being characterized by the following process steps:
providing a steel component and producing at least one recess, which extends through the steel component and which tapers in cross section towards the bottom side of the steel component that lies opposite the light metal component that is to be subsequently attached;
providing a light metal component;
butt joining the light metal component and the steel component in a positive locking manner at least in certain sections;
inserting the weld filler material into the recess and welding by metallurgically bonding the weld filler material with the light metal component;
wherein the light metal component and the weld filler material form a positive locking connection with the steel component.

Furthermore, it is particularly preferred that the steel component be produced and formed by thermoforming and press hardening, before the steel component is coupled with the light metal component. In this case, it is particularly preferred that the recesses be introduced before or during the thermoforming and the press hardening. The welding of the weld filler material with the light metal component does not affect or only negligibly affects the resulting strength properties of the hardened steel component.

Furthermore, it is possible that the steel component or, more specifically, steel strip or rather a steel blank for producing the steel component is coated. After the coating operation has been completed, the recess can then be produced. The (uncoated) inside edge or, more specifically, the inner circumferential surface of the recess can be sealed by the melting of the filler material in such a way that corrosion is avoided and/or that the filler material is connected by metallurgical bonding to the coating lying on the top side of the steel component, such that in this case, too, sealing also takes place.

For this purpose it is particularly preferred that the melting temperature of the weld filler material be at or below the melting temperature of the coating.

When using a weld filler material that contracts/shrinks selectively upon cooling, the steel component is pressed simultaneously against the light metal component due to the shrinkage or, more specifically, the contraction of the weld filler material.

Other advantages, features, properties and aspects of the present invention are the subject matter of the following description. Preferred variants of the embodiment of the invention are shown in schematic form in the figures. These variants of the embodiment of the invention serve only to make it easier to understand the invention.

### BRIEF DESCRIPTION OF THE DRAWINGS

FIG. 1 consists of FIG. 1A, FIG. 1B, FIG. 1C and FIG. 1D showing a plan view and a cross sectional view of a hybrid component that is produced according to the invention;

FIG. 2 consists of FIG. 2A, FIG. 2B and FIG. 2C showing a number of variants of the embodiment of the hybrid component in a cross sectional view;

FIG. 3 consists of FIG. 3A, FIG. 3B and FIG. 3C showing a number of plan views of a variety of recesses;

FIG. 4 consists of FIG. 4A, FIG. 4B and FIG. 4C showing a plan view, a rear view and a side view of a bumper assembly, produced with the joining method of the invention;

FIG. 5 consists of FIG. 5A, FIG. 5B and FIG. 5C showing an alternative variant of the embodiment shown in FIG. 4;

FIG. 6 consists of FIG. 6A, FIG. 6B and FIG. 6C showing an additional alternative variant of the embodiment shown in FIG. 4;

FIG. 7 consists of FIG. 7A, FIG. 7B and FIG. 7C showing an alternative variant of the embodiment shown in FIG. 4;

FIG. 8 consists of FIG. 8A & FIG. 8B showing a motor vehicle pillar, produced with the method of the invention;

FIG. 9 shows a door panel, produced with the method of the invention;

FIG. 10 consists of FIG. 10A & FIG. 10B showing a cross sectional view of an inventive hybrid component with a coated steel component;

FIG. 11 consists of FIG. 11A & FIG. 11B showing an additional alternative embodiment of the recess with edge-sided opening; and

FIG. 12 shows a variant of the embodiment of a hybrid component according to the invention.

### DETAILED DESCRIPTION OF THE INVENTION

The same reference numerals are used for identical or similar components in the figures, even if the description is not repeated for the sake of simplicity.

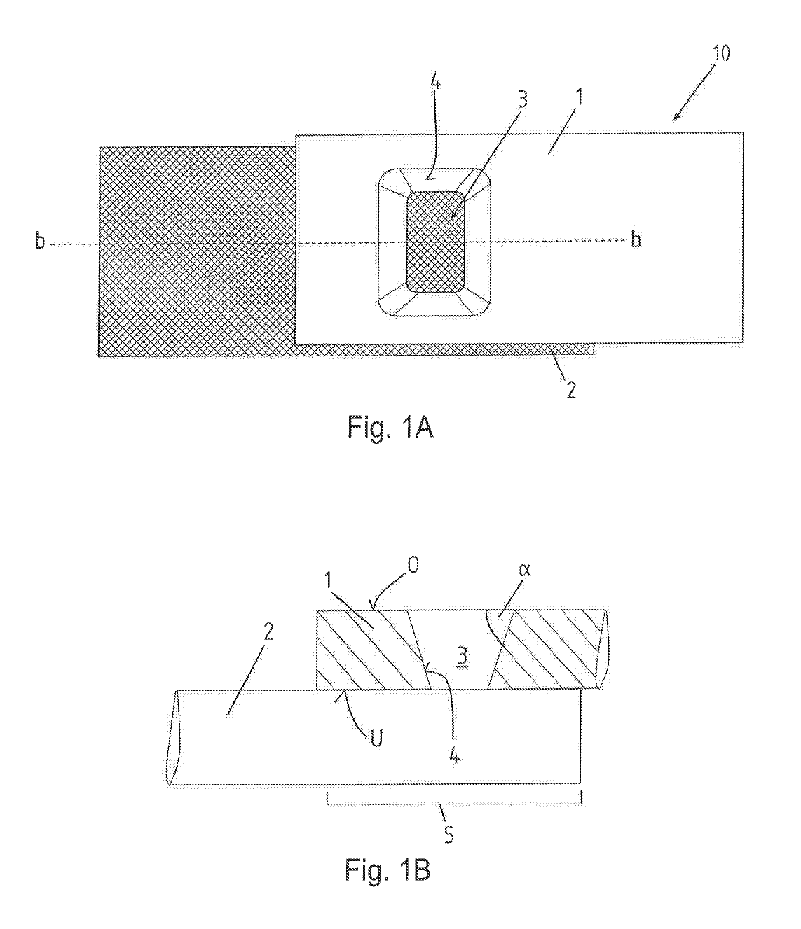

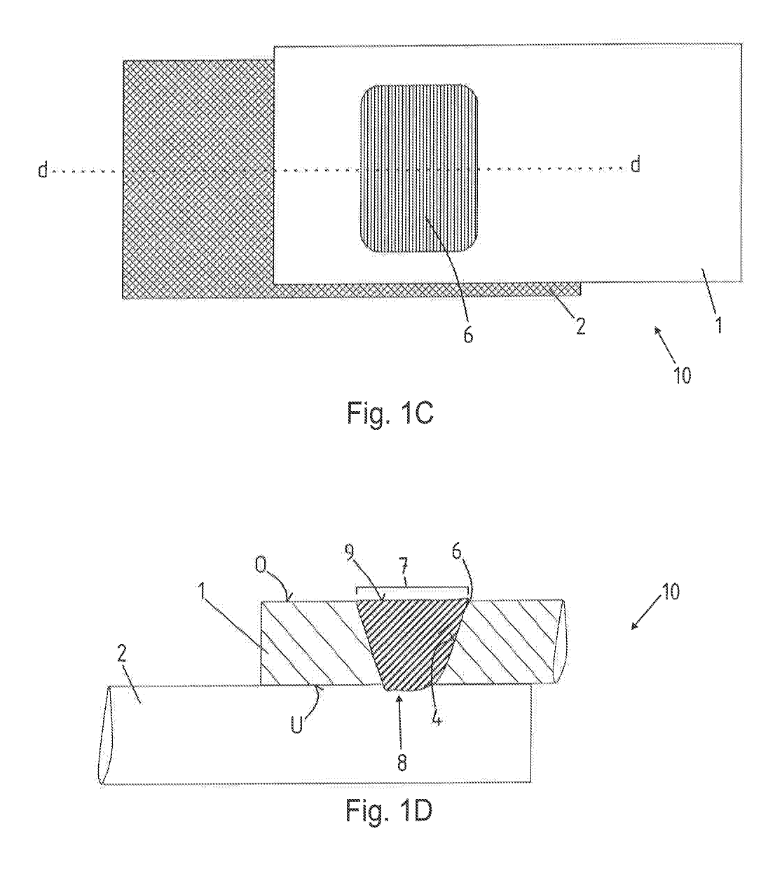

FIGS. 1A) to C) show in each case a plan view and a cross sectional view of the inventive hybrid component before and after the joining process. FIG. 1A) shows a plan view of the steel component 1 with the subjacent light metal component 2. The steel component 1 has a recess 3, within the steel component from a top side O to a bottom side U. In this case, the recess 3 is formed so as to taper towards the light metal component 2 or, more specifically, towards the bottom side U. As a result, an inner circumferential surface 4 of the recess 3 is designed, in particular, to converge or, more specifically, to taper conically. The inner circumferential surface 4 runs at an angle α to the top side O. In FIG. 1B), it can be seen in the cross section that the light metal component 2 and the steel component 1 rest with their surfaces flush against each other in a positive locking manner in a section 5.

According to FIG. 1C), the recess 3 is filled up with a weld filler material 6. As a result, the V-shaped cross sectional course (shown in FIG. 1B)) of the tapering recess 3 forms, in interaction with the weld filler material 6, a positive locking shape, with the effect that a joint connection 7 from the light metal component 2 to the steel component 1 is produced. Correspondingly, the weld filler material 6 engages, in particular, with the inner circumferential surface 4 of the recess 3 in a positive locking manner. The weld filler material 6 is coupled by metallurgical bonding with the light metal component 2 in a coupling region 8. Furthermore, it can be seen in FIG. 1D) that the weld filler material 6 is designed to terminate more or less level with the top side O of the steel component 1 and even has a flat top surface 9 for producing the hybrid component.

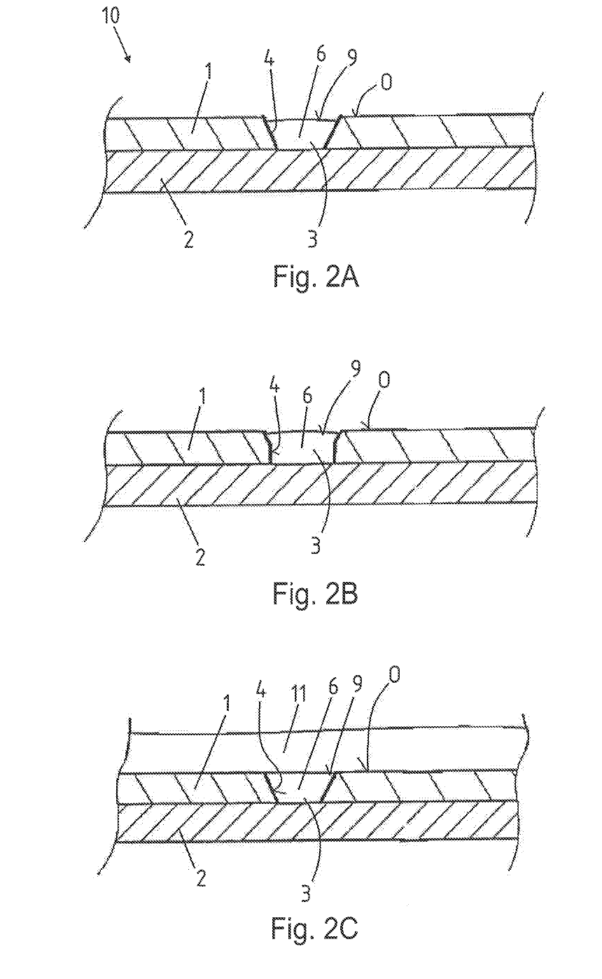

FIG. 2 shows in each instance a cross section of an inventive hybrid component 10 in certain regions, where in this case, the steel component 1 is disposed at the top and the light metal component 2 is disposed at the bottom relative to the image plane. It can be seen in FIG. 2A) that in this case, too, the recess 3 with its inner circumferential surface 4 is designed in a V shape tapering in the direction of the light metal component 2. As a result, a positive locking shape is produced by means of the weld filler material 6. However, the weld filler material 6 is designed in such a way that it extends through the recess 3 only in certain regions or, more specifically, in certain sections and, thus, is moved back with its surface 9 opposite the top side O of the steel component 1.

According to one variant of the embodiment shown in FIG. 2B), the cross section or, more specifically, the inner circumferential surface 4 is designed in such a way that it has a Y shape in cross section. As a result, the recess 3 has only a partially chamfered hole edge or, more specifically, recess edge. In this case, too, the weld filler material 6 is designed so as to extend only partially through the steel component 1, thus, it does not terminate level until as far as up to the top side O.

According to the embodiment from FIG. 2C), a sealing system 11 is also applied to the hybrid component 10, where in this case the top side O of the steel component 1 is formed so as to terminate more or less level with the surface 9 of the weld filler material 6 that is disposed in the recess 3.

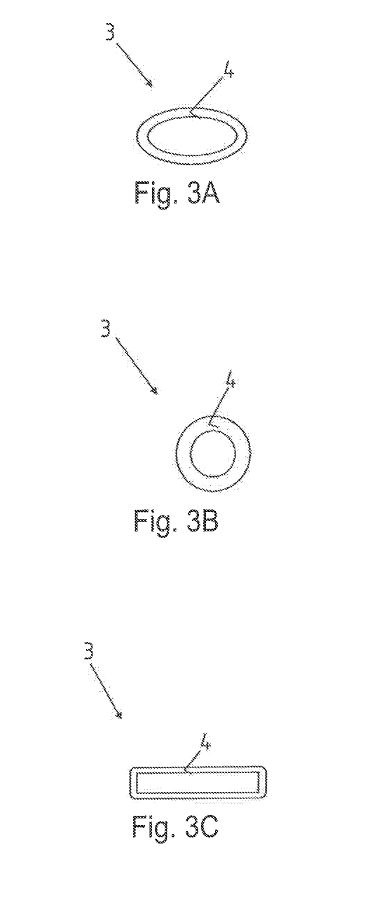

FIGS. 3A) to C) show a number of variants of the embodiment of the recess 3 in plan view. According to FIG. 3A), it is possible to form this recess in such a way that it is elliptical; according to FIG. 3B), round, in particular, circular; and, according to FIG. 3C), rectangular or, more specifically, in the form of a slot. The recesses 3 taper into the image plane, such that the inner circumferential surface 4 is visible.

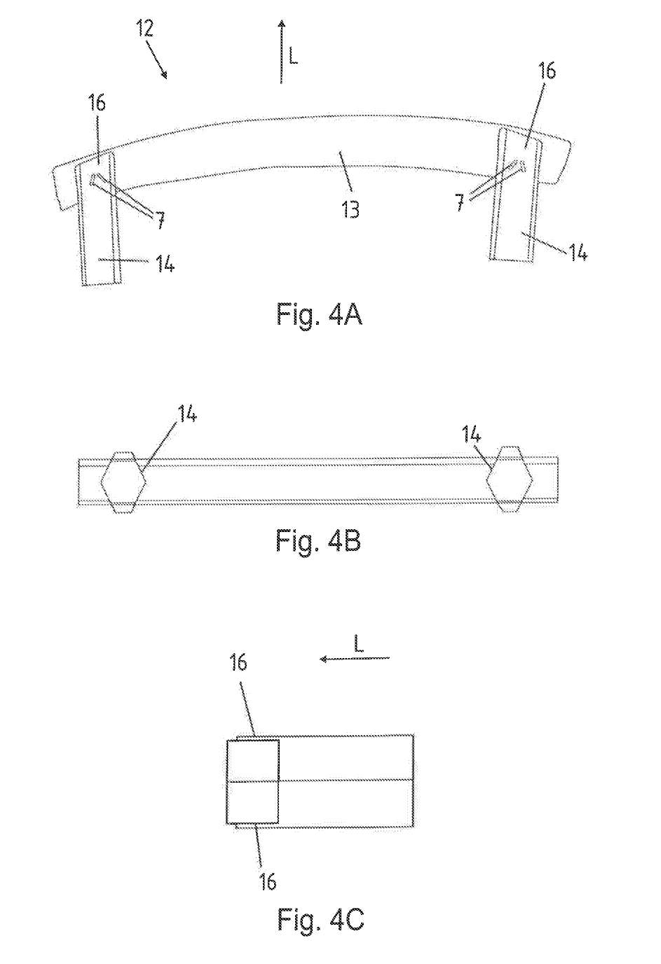

FIGS. 4A) to C) show an application of the inventive hybrid component 10 as a bumper assembly 12, comprising a bumper transverse beam 13 as well as crash boxes 14, disposed in the end regions of the bumper transverse beam 13, in a plan view in the case of FIG. 4A). The crash boxes are formed in the shape of a slot in the joint connections 7, where in this case two slots are arranged in a V shape relative to each other. It can be seen in FIG. 4B) that the crash boxes 14 have a hexagonal cross section and are constructed as a steel component 1. The bumper transverse beam 13 is constructed as a light metal component, in particular, as an extrusion component. Furthermore, it can be seen that the crash boxes 14 together with the flanges 16 engage, according to FIG. 4C), over the bumper transverse beam 13 at least in sections in the longitudinal direction L. In this case, the bumper transverse beam 13 is designed preferably as a multiple chamber hollow profile. In particular, a steel material having high strength or ultra high strength properties is used; and a 5000, 6000 or 7000 series aluminum alloy is used as the light metal alloy.

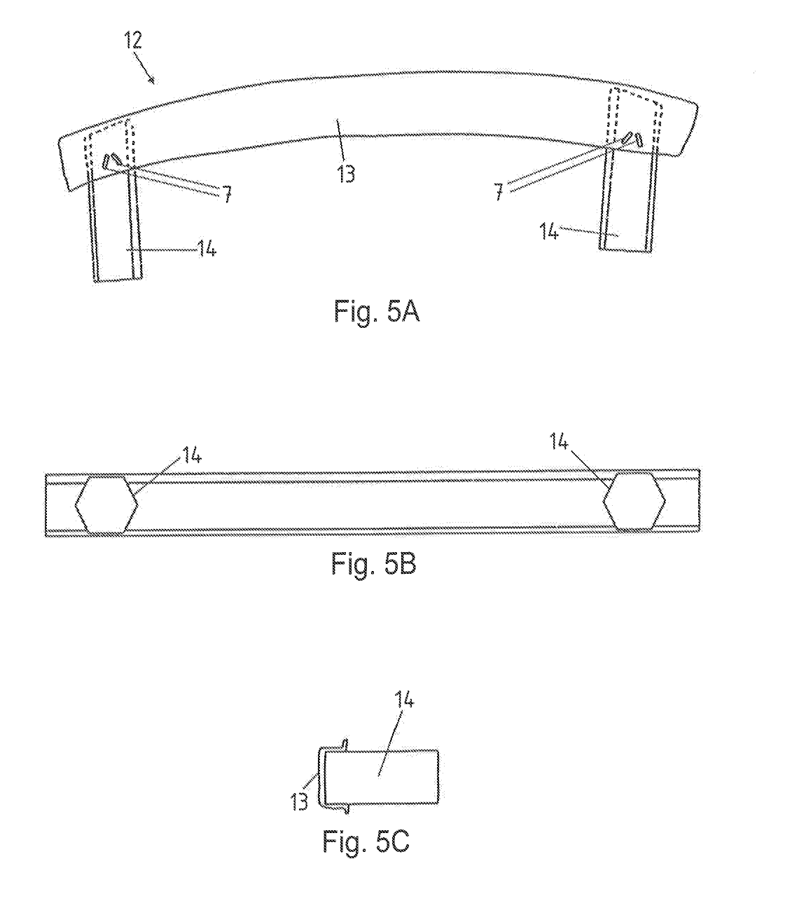

FIGS. 5A) to C) show an alternative variant of the embodiment, also comprising a bumper transverse beam 13 as well as crash boxes 14, disposed in the region of the ends. However, in this case, the bumper transverse beam 13 is constructed as a steel component 1, for which reason the crash boxes 14, which are also designed so as to be hexagonal in the cross section, engage within bumper transverse beam, a feature that can be seen very clearly, in particular, in FIG. 5C). The bumper transverse beam 13 has a cross section in the shape of a C. Similarly, the joint connections 7 in turn are also arranged in a V shape relative to each other and, engaging the bumper transverse beam 13 from behind, connect the crash boxes 14, which are made of light metal, to the bumper transverse beam in a positive locking manner.

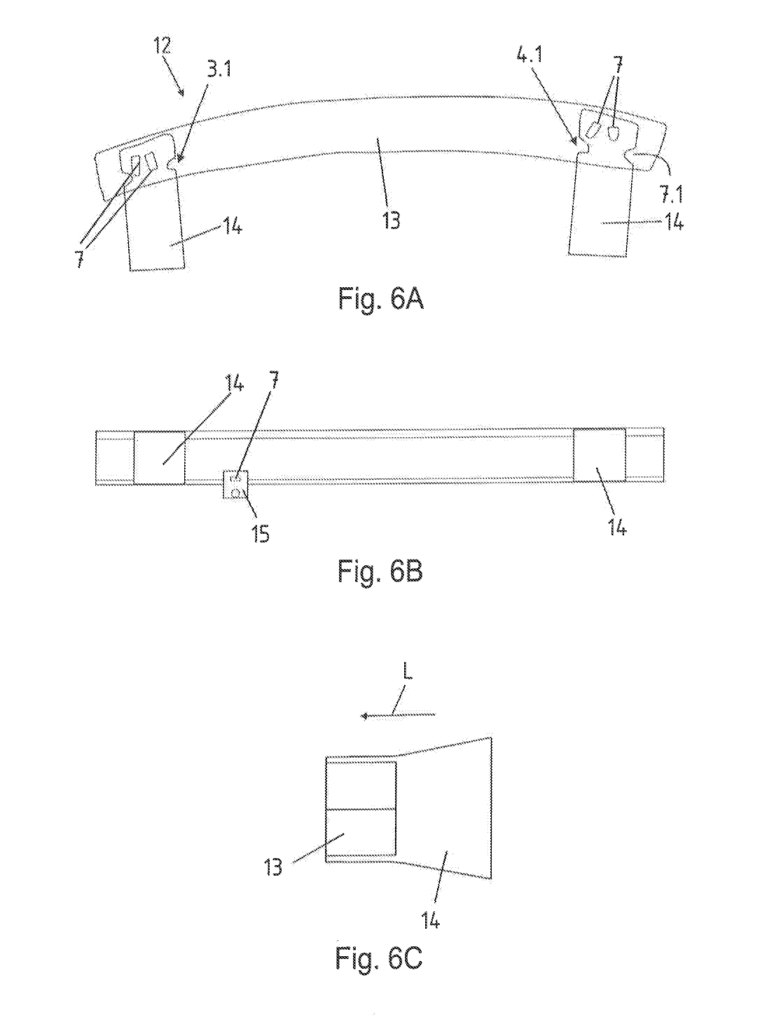

FIGS. 6A) to C) show an alternative variant of the embodiment of a bumper assembly 12, comprising a bumper transverse beam 13 made of a light metal alloy as well as crash boxes 14 made of a steel alloy. A plate 15 for a tow hook is also coupled with the bumper transverse beam 13 made of a light metal. Both the crash boxes 14 and the tow hook plate 15 are coupled with the bumper transverse beam 13 with the joint connection 7 of the invention. It can be seen very clearly in FIG. 6C) that the crash boxes 14 expand in the longitudinal direction L towards a motor vehicle that is not depicted in greater detail. Additional recesses 3.1 with partial circumferential surfaces 4.1 provide additional connections 7.1, as a result of which it is even easier to counteract transverse loads.

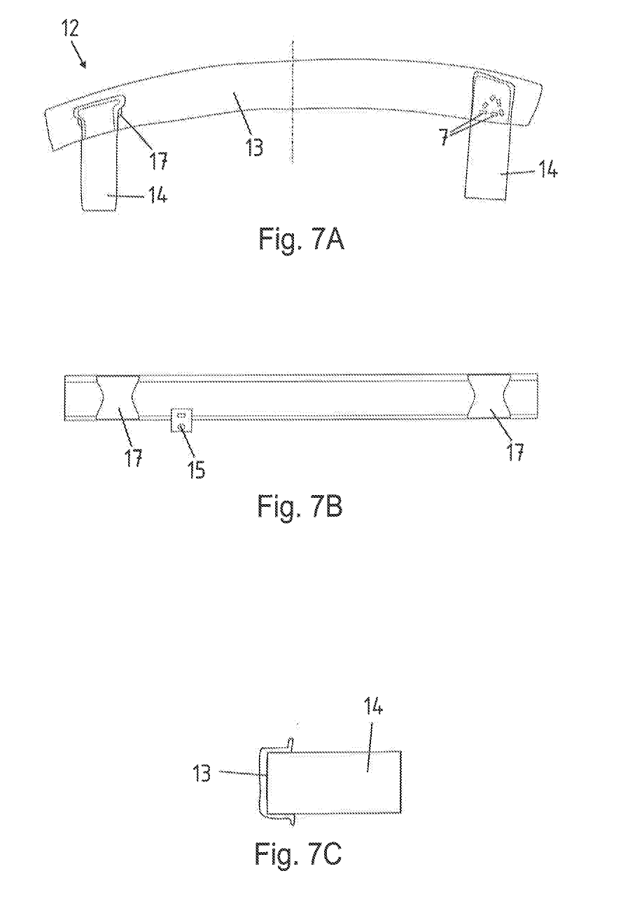

FIGS. 7A) to C) show a bumper assembly 12, comprising a transversely extending bumper transverse beam 13 as well as crash boxes 14, each being disposed in the respective end region of the bumper transverse beam 13. The crash boxes 14 themselves are made of a light metal alloy as sheet metal parts; and the bumper transverse beam 13 is made of a steel material. It can be seen very clearly in FIG. 7C) that the crash boxes 14 are inserted into the bumper transverse beam 13 in such a way that they support the front wall of the bumper. On the left hand side relative to the image plane of FIG. 7A), a two-sided edge weld 17 has been made as a positive locking connection.

On the right-hand side relative to the image plane of FIG. 7A), a plurality of joint connections 7 of the invention are arranged in a triangular configuration or, more specifically, in the shape of a pyramid. It can be seen in FIG. 7B) that the crash boxes 14 are formed in the shape of an X or, more specifically, in the shape of an hourglass in cross section. The two different joint connections on the left side and the right side of the bumper transverse beam 13 are variants that, when taken alone, can be used, of course, on both sides to connect the crash box 14 and the bumper transverse beam 13.

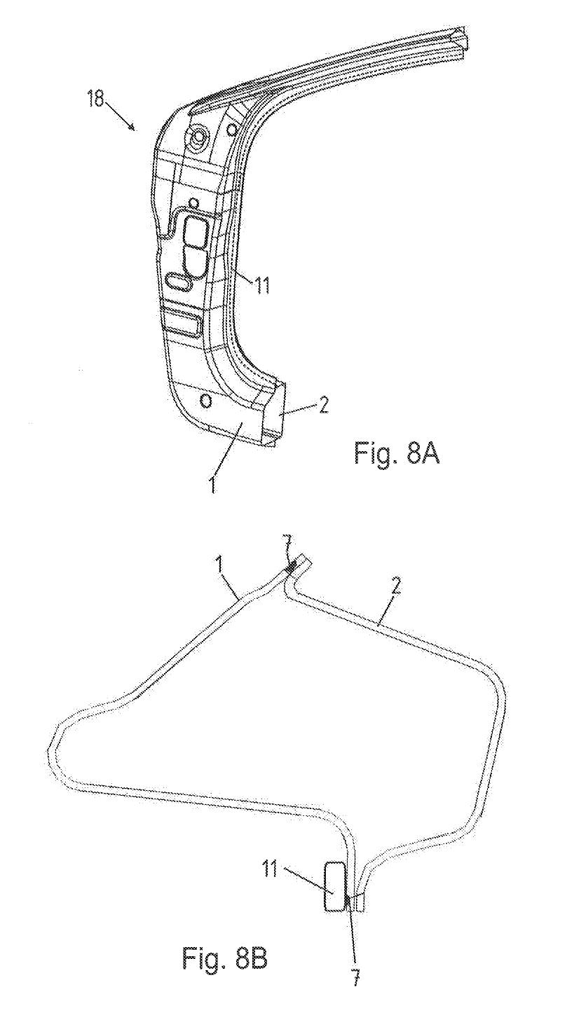

FIGS. 8A) and B) show another variant of the embodiment of the inventive hybrid component in the form of an A pillar 18. For this purpose, one component is designed as a steel component 1; and one component is designed as a light metal component 2. Furthermore, there is a sealing system 11, where in this case the joint connection 7 terminates flush with the surface of the steel part in the region that is at the bottom in relation to the image plane of FIG. 8B); and a flat attachment surface without a projecting length or damage to the sealing system is guaranteed.

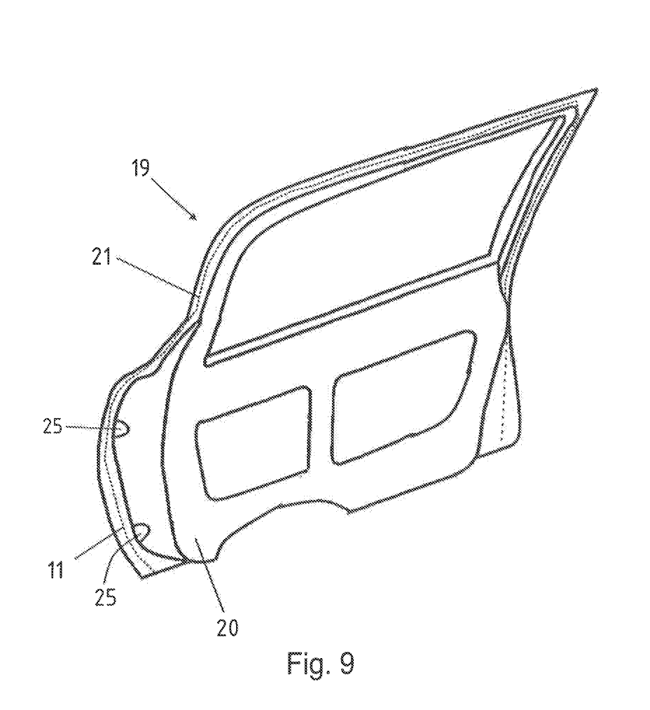

FIG. 9 shows an additional variant of the embodiment of the invention in the form of an inner door panel 20 of a door 19 of a motor vehicle. The door 19 of the motor vehicle has an inner door panel 20, which has an external circumferential steel reinforcement, for example, in the form of a steel frame 21. On the steel frame 21, there is also a circumferential sealing system 11 and a lock reinforcement 25. The lock reinforcement 25 can also be produced as a hybrid construction with the method according to the invention.

In the region of the sealing system, the inventive recesses in the steel component 1 are filled in an securing manner by means of the weld filler material 6 by means of the inventive recess 3, with the effect that the joint connection 7 to the inner door panel 20 is formed. Additional joint connections 7 can be seen when coupling the inner door panel 20 with the lock reinforcement 25.

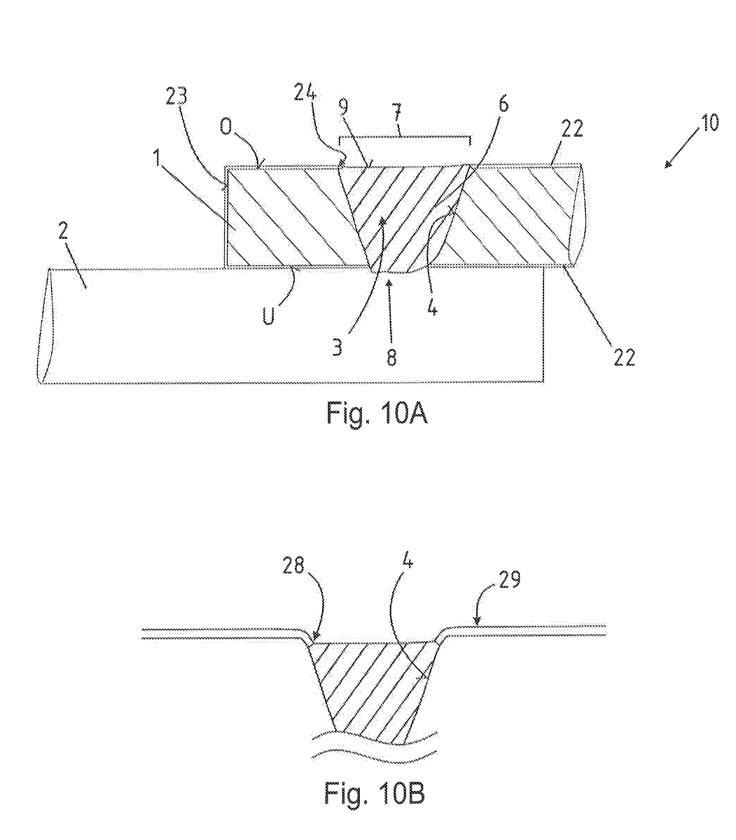

Furthermore, it can be seen in FIG. 10B) that the coating already existed prior to the introduction of the recess 3 in the steel component 1. Consequently, the edge 28 of the coating 29 is bent down or rather is introduced in the direction of the recess 3 towards the light metal component 2. As a result, the metallurgical connection completely covers the surface of the coating and prevents impurities from penetrating into the surface of the coating, in particular, prevents moisture from making contact with the inner circumferential surface 4 of the recess 3.

FIG. 10 shows a hybrid component 10 analogous to FIG. 1D). However, in addition, the steel component 1 is provided with a circumferential coating 22, where in this case the coating 22 is formed on the top side O, the bottom side U as well as the end face 23 of the steel component 1. Owing to the fact that the recess 3 is not introduced until after the coating has been applied, the inner circumferential surface 4 of the recess 3 is not coated. However, the surface O of the weld filler material 6 is coupled with the coating 22 by metallurgical bonding at a circumferential connection 24, such that no impurities and, in particular, no moisture can penetrate between the weld filler material 6 and the inner circumferential surface 4 as well as between the surface O and the coating 22.

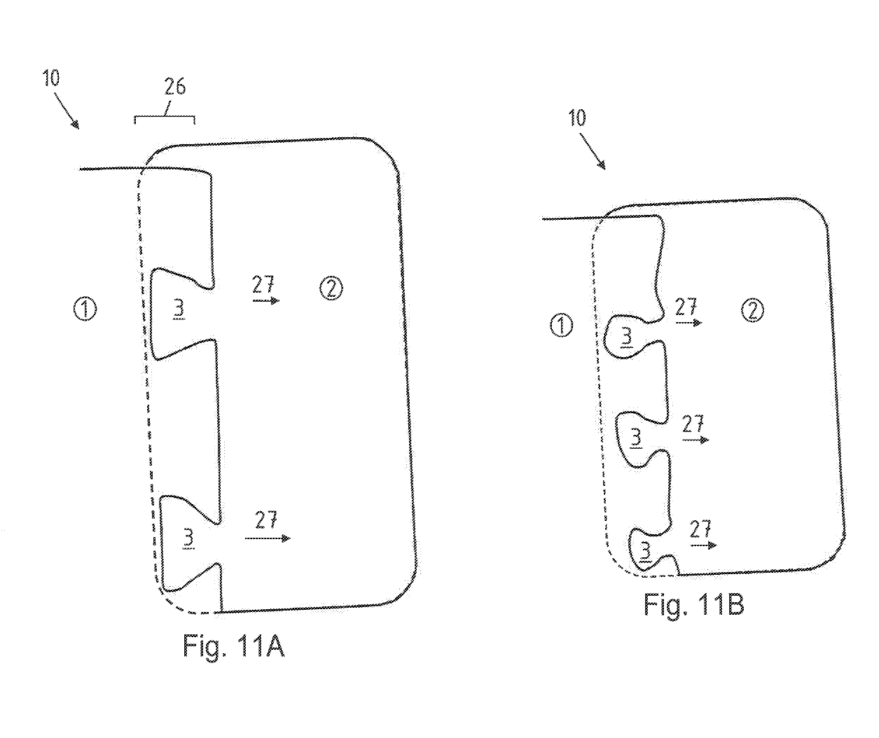

FIGS. 11A) and B) show a respective variant of the embodiment of the inventive hybrid component 10, where a steel component 1, which is located at the top in relation to the image plane, is coupled with a subjacent light metal component 2. They overlap only in an edge region 26, where in this case the recesses 3 in the steel component 1 taper in the direction 27, thus, towards the light metal component 2. In addition, but not shown in greater detail herein, the recesses 3 in the steel component 1 may also taper into the image plane. After the weld filler material 6 has been introduced, the weld filler material engages at the edge of the steel component 1 in the manner of a head of a jigsaw puzzle piece.

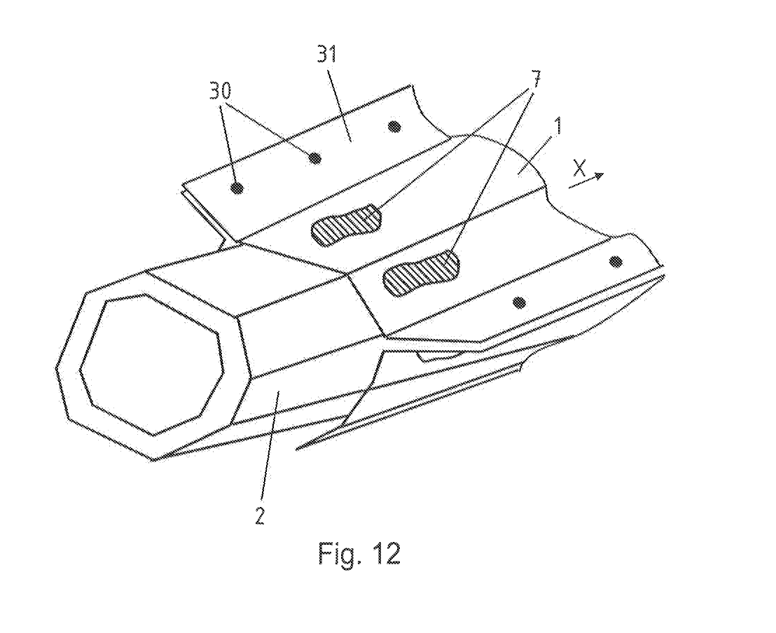

FIG. 12 shows an additional variant of the embodiment of the hybrid component of the invention. In this case, the steel component 1 is formed from individual steel shells, which are coupled to each other by means of spot welding connections 30 by way of a flange 31. Then, the light metal component 2 is inserted in a positive locking manner, as a longitudinal profile component, into a shell or, more specifically, a receiving opening, which is formed by the steel component 1, and is coupled by means of the joint connection 7 of the invention. In particular, this arrangement enables an additional positive locking fixation against displacement in the X direction. For example, it can be designed as an attachment of a roof frame, such that the light metal component 2 is produced as a roof frame; and the steel component 1 is designed as an attachment area for a pillar of a motor vehicle, for example, as an A pillar.

### LIST OF REFERENCE NUMERALS AND SYMBOLS

1—steel component
2—light metal component
3—recess
3.1—recess
4 —inner circumferential surface with respect to 3
4.1—inner circumferential surface with respect to 3
5 —section
6 —weld filler material
7 —joint connection
7.1 joint connection
8 —coupling region
9 —surface with respect to 6
10—hybrid component
11—sealing system
12—bumper assembly
13—bumper transverse beam
14—crash box
15—tow hook plate
16—flange
17—positive locking edge weld
18—hybrid A pillar
19—door of a motor vehicle
20—inner door panel
21—steel frame
22—coating
23—end face
24—connection
25—lock reinforcement
26—edge region
27—direction
28—edge
29—coating
30—spot weld connection
31—flange
L—longitudinal direction
O—top side with respect to 1
U—bottom side with respect to 1
α—angle

1. A hybrid component comprising a steel component and a light metal component, wherein the steel component rests with its surface flush against the light metal component at least in certain areas; and a joint connection in the steel component has a form fit connection, the connection being formed by a recess, which extends through the steel component and tapers towards the light metal component, wherein a weld filler material, which is bonded with the light metal component by metallurgical, bonding, is in the recess, wherein the weld filler material extends from the light metal component only partially through the recess, or that an upper surface of the weld filler material terminates level with a top surface of the steel component.

2. A hybrid component comprising a steel component and a light metal component, wherein the steel component rests with its surface flush against the light metal component at least in certain areas; and a joint connection in the steel component has a form fit connection, the form fit connection being formed by a recess, which extends through the steel component and tapers towards the light metal component, wherein a weld filler material, which is bonded with the light metal component by metallurgical bonding is in the wherein the steel component is coated; and the weld filler material is bonded to the coating by metallurgical bonding.

3. The hybrid component, as claimed in claim 1, wherein the steel component has high strength or ultra high strength material properties, and/or that the hybrid component is designed as a hybrid component of a motor vehicle.

4. The hybrid component, as claimed in claim 1, wherein the recess is a V shape or a Y shape in cross section.

5. The hybrid component, as claimed in claim 4, wherein the legs of the V shape or the Y shape have a linear, progressive or degressive form.

6. The hybrid component, as claimed in claim 1, wherein the recess is designed so as to be round, star shaped, polygonal or a combination of the aforementioned shapes, and/or that the recess is designed as a slot.

7. The hybrid component, as claimed in claim 1, wherein the steel component is coated.

8. The hybrid component, as claimed in claim 1, wherein a plurality of joint connections are arranged at a respective distance from each other in a longitudinal orientation.

9. The hybrid component, as claimed in claim 2, wherein a sealing system is disposed on the joint connections, in particular, in a longitudinal orientation.

10. The hybrid component, as claimed in claim 1, wherein an inner circumferential surface of the recess is not coated; and that the weld filler material extends through the recess as far as the coating of the steel component, the coating lying opposite the light metal component; in particular, the weld filler material is bonded to the coating by metallurgical bonding.

11. The hybrid component, as claimed in claim 2, wherein the weld filler material extends from the light metal component to only partially extends through the recess, or that a top surface of the weld filler material terminates level with the top surface of the steel component.

12. A method for producing a hybrid component, as claimed in claim 1, containing the following process steps:
providing a steel component and producing at least one recess, which extends through the steel component and which tapers in cross section towards a bottom side of the steel component, the bottom side being opposite the light metal component that is to be subsequently attached;
providing a light metal component;
butt joining the light metal component and the steel component in a positive locking manner at least in certain sections;
inserting a weld filler material into the recess and welding by metallurgical bonding the weld filler material with the light metal component;
wherein the light metal component and the weld filler material forms a form fit connection with the steel component.

13. The method, as claimed in claim 12, wherein the steel component is coated, in particular, with a coating that together with the surface of the steel component forms an intermetallic phase.
